(19) United States
(12) Patent Application Publication
(10) Pub. No.: US 2006/0255679 A1
(43) Pub. Date: Nov. 16, 2006

(54) Apparatus for pole pieces

(76) Inventors: Pieter Van Dine, Mystil, CT (US); Spyro Pappas, Fort Lee, NJ (US); Mihai Georghiu, Boynton Beach, FL (US); Daniel Kane, Pawcatuck, CT (US); Vladimir Odessky, Trenton, NJ (US); Michael Salata, Pawcatuck, CT (US); Robert S. Forney III, Stonington, CT (US); Alberto Franco, Salem, CT (US); Michael Quadrini, Brunswick, ME (US)

Correspondence Address: HOWREY LLP, C/O IP DOCKETING DEPARTMENT, 2941 FAIRVIEW PARK DR, SUITE 200, FALLS CHURCH, VA, 22042-2924, US

(21) Appl. No.: 11/327,378

(22) Filed: Jan. 9, 2006

Related U.S. Application Data
(63) Continuation of application No. 11/128,245, filed on May 13, 2005, now abandoned.

(51) Int. Cl. H02K 1/27

(52) U.S. Cl. 310/156.55; 310/156.19

(57) ABSTRACT

An embodiment generally relates to a permanent magnet rotor arrangement. The arrangement includes a rotor having a plurality of apertures, a plurality of pole pieces, a plurality of wedges, and a plurality of permanent magnets. Each magnet is held substantially secure against the rotor by a two pole pieces of the plurality of pole pieces and an associated wedge from the plurality of wedges. Each pole piece is connected to the rotor by a fastener pulled through an associated aperture.

### FIELD OF THE INVENTION

This invention relates generally to electric motors. More particularly, the invention relates to an arrangement for pole pieces in electric motors.

### DESCRIPTION OF THE RELATED ART

Electric motors are generally useful devices. They may be used to assist in the operation of many everyday items such as garage doors or drills. One type of motor is a permanent magnet motor. A permanent magnet motor may be selected for an application because of a need for high torque, high efficiency or quick acceleration.

Permanent magnet rotors generally utilize curved magnets, which are fixed with adhesive to the periphery of the rotor (surface mounted). Other permanent motor rotors, utilize magnets embedded between the laminated steel rotor poles. In that case, stacks of rotor laminations which form pole pieces are generally secured to the rotor using threaded fasteners or dovetails. Use of the dovetails typically increases rotor cost and adds excessive parts to the rotor assembly. Use of the threaded fasteners limits the accuracy of the pole attachment.

For example, U.S. Pat. No. 6,452,301 to Van Dine et al. (“Van Dine”) describes a method of attaching magnets in a high speed rotor through the use of pole pieces and slot wedges. Although this method is effective for attaching pole pieces, precision is often necessary in permanent magnet motors. Unfortunately, precisely locating rotor pole pieces in permanent magnet motor and generator rotors is difficult to achieve with the simple keys and fasteners and, as a result, such rotors exhibit reduced performance. Such precision is necessary when using the rotor for applications where torque fluctuations and cyclical radial loads must be kept to a minimum. Moreover, the inability to provide precise radial position and angular orientation of rotor parts may degrade overall rotor or generator performance, cause unacceptable vibration levels and reduce efficiency.

In addition, loosening of the rotor assembly may occur during operation due to normal motor or generator vibration. Loosening of parts may degrade performance or, worst, cause mechanical damage to motor or generator parts. Thus, degraded performance and/or mechanical damage may result from magnets separating from the rotor.

U.S. Pat. No. 5,952,755 to Lubas (“Lubas”). describes an arrangement that provides for positional control of rotor components. More particularly, as shown in FIG. 9, Lubas describes the use of tapered retaining wedges to pull the rotor poles inward and permanently attach the rotor poles to the rotor cylinder. Once the tapered wedges are engaged, permanent magnets are installed and held in place radially using slot wedged between the rotor poles.

Although the arrangement described by Lubas is effective in positioning pole pieces, this arrangement has drawbacks and disadvantages. For instance, the Lubas arrangement has structural capability that is restricted by the size of the tapered (or restraining) wedges. In other words, use of restraining wedges restrains the size of the permanent magnet motors to the larger sized motors.

Another disadvantage is that the restraining wedges are expensive to manufacture and are susceptible to damage during initial installation (often requiring replacement). As a result, the cost of these types of motors increases. Yet another disadvantage is that it is difficult to evenly tighten the pole pieces to the rotor cylinder because of the taper of the restraining wedges. The uneven tightening of the pole pieces may result in uneven distortion of the pole surface from the mechanical force exerted by the tightening of the restraining wedges and thus, distorting the flux path and increasing the negative effect on motor electro-magnetics.

### SUMMARY

One embodiment pertains to a permanent magnet rotor arrangement. The permanent motor rotor arrangement includes a rotor having a plurality of apertures, a plurality of pole pieces, a plurality of wedges, and a plurality of permanent magnets. Each magnet is substantially secured against the rotor by two pole pieces of the plurality of pole pieces and an associated wedge from the plurality of wedges. Each pole piece is connected to the rotor by a retaining key held in place by a fastener pulled through an associated aperture.

Another embodiment generally relates to a permanent magnet rotor arrangement. The permanent motor arrangement includes a rotor and a plurality of dovetails adapted to be attached to the rotor. The permanent magnet motor arrangement also includes a plurality of pole pieces, each pole configured with an opening to receive an associated dovetail and a plurality of permanent magnets. Each magnet is held substantially secure against the rotor by a two pole pieces of the plurality of pole pieces, the pole piece engaging a respective dovetail.

Yet another embodiment generally pertains to a pole piece arrangement. The pole piece arrangement includes a rotor having a plurality of openings and a pole piece having a horizontal opening through the length of the pole piece and a vertical opening to the horizontal opening. The pole piece arrangement also includes a retaining member configured to engage the pole piece in the horizontal opening and a fastener engaging the retaining member through the vertical opening. The pole piece is attached to the rotor through a selected opening of the plurality of openings.

Yet another embodiment generally relates to a pole piece arrangement. The pole piece arrangement includes a rotor having a plurality of openings and a plurality of pole pieces. Each pole piece has a horizontal opening through the length of the pole piece and a vertical opening to the horizontal opening. The pole piece arrangement also includes a plurality of retaining members, where each retaining member configured to engage an associated pole piece in the horizontal opening. The pole piece arrangement further includes a plurality of fasteners, where each fastener engages an associated retaining member through the vertical opening of a selected pole piece. The selected pole piece is attached to the rotor through a selected opening of the plurality of openings.

### BRIEF DESCRIPTION OF THE DRAWINGS

Various features of the embodiments may be more fully appreciated as the same become better understood with reference to the following detailed description of the embodiments when considered in connection with the accompanying figures, in which:

FIG. 1 illustrates a longitudinal sectional view of shaft and a permanent magnet motor rotor in accordance with an embodiment;

FIG. 2 illustrates an exemplary embodiment of a pole piece arrangement;

FIG. 3 illustrates another exemplary embodiment of a pole piece arrangement;

FIG. 4 illustrates yet another exemplary embodiment of a pole piece arrangement;

FIG. 5 illustrates yet another exemplary embodiment of a pole piece arrangement;

FIG. 6A illustrates yet another exemplary embodiment of a pole piece arrangement;

FIG. 6B illustrates a more detailed view of the retaining key in this embodiment;

FIG. 7 illustrates yet another exemplary embodiment of a pole piece arrangement;

FIG. 8 illustrates yet another exemplary embodiment of a pole piece arrangement; and

FIG. 9 illustrates a conventional method of attaching a pole piece to a rotor.

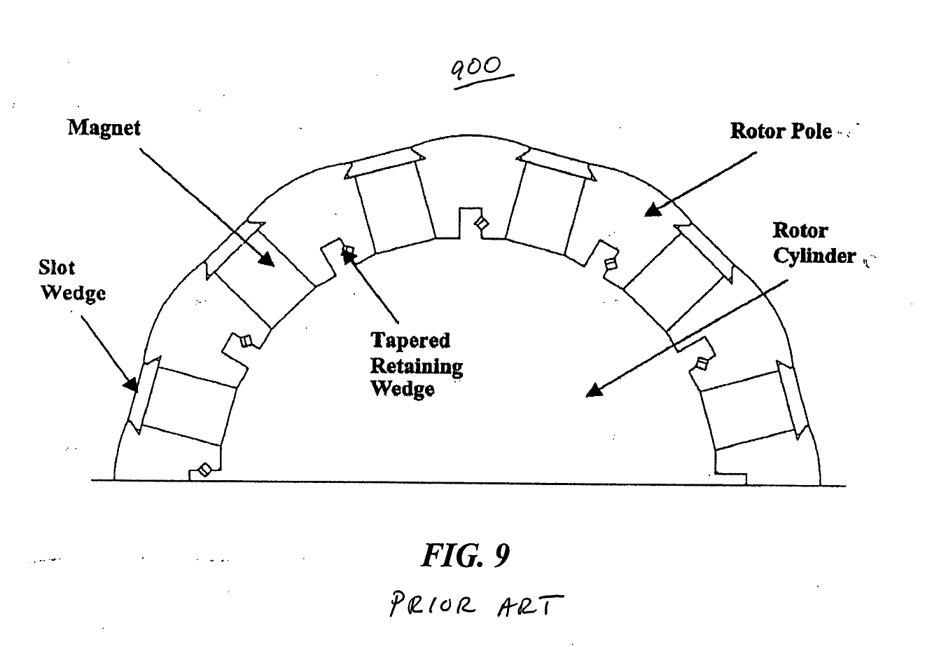

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and may be implemented in, all types of electrical motors, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments generally pertain to electric motors with permanent magnets. More particularly, an embodiment includes a rotor cylinder with a plurality of apertures uniformly distributed along the circumference of the rotor. Pole pieces are also distributed along the circumference of the rotor. Each pole piece has a horizontal opening extending through the length of the pole piece. Each pole piece also has a vertical opening extending from the bottom of the pole piece to the horizontal opening. The vertical opening of the pole piece may be configured to receive a fastener member. The fastener member may be configured to have a key opening at one end.

In one embodiment, the fastener member with the key opening may be inserted into the vertical opening of the pole piece. A retaining key may then be inserted into the horizontal opening of the pole piece and engaging the key opening of the inserted fastener member. The retaining key may be substantially the same length of the pole piece. The other end of the fastener member may be attached to a rotor cylinder, and thus circumferentially distributing the pole pieces. In some respects, the attached pole pieces on the rotor cylinder form a cog-like apparatus. Magnets may be inserted into the gaps between two attached pole pieces, which also circumferentially distributes the magnets along the rotor cylinder.

The magnets are substantially secured against the rotor cylinder by inserting a slot wedge between two pole pieces. More specifically, in another embodiment, each pole piece also includes a notch, slot, or channel configured to receive one side of the slot wedge. After the magnet is placed into the space formed by two fastened pole piece, the slot wedge is placed into the channels of the pole pieces, and thereby forming a restraining structure that holds the magnet secure against the rotor cylinder.

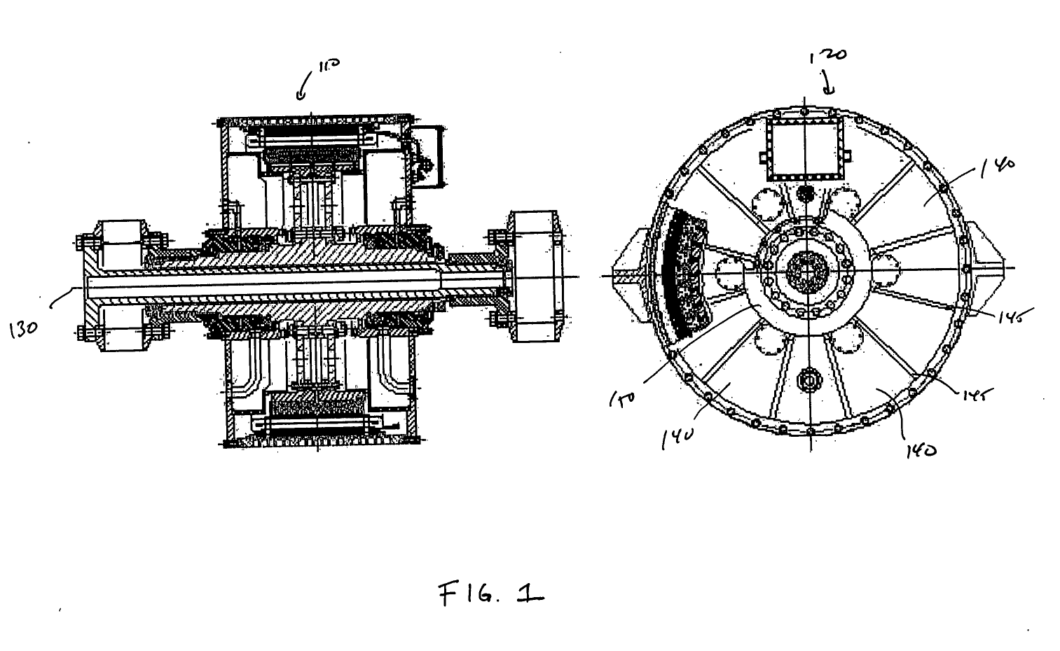

FIG. 1 illustrates a longitudinal sectional view of a permanent magnet motor 110 and a permanent magnet motor rotor 120 in accordance with an embodiment. As shown in FIG. 1, the permanent magnet motor 110 includes a shaft 130. The permanent magnet motor 110 also includes a rotor 120 configured to rotate around the shaft 130. Permanent magnet motor 110 may be used in typical application for permanent magnet motors.

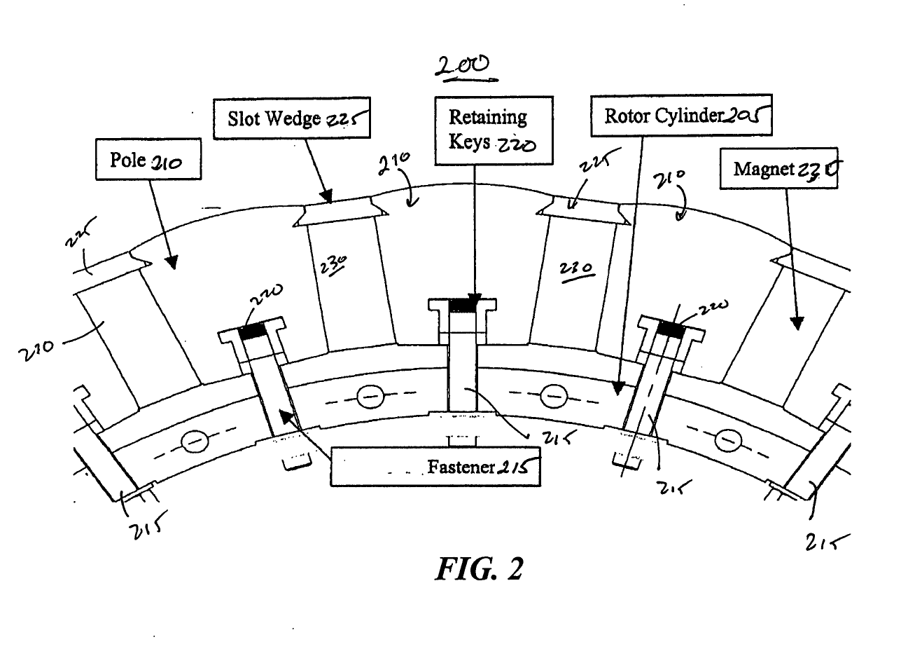

The rotor 120 includes a number of pole pieces 140 and magnets 145 attached to a rotor cylinder 150. Although not shown in FIG. 1, the rotor 120 includes slot wedges, retaining keys and fasteners in accordance with an embodiment of the invention, which are shown in greater detail with respect to FIG. 2.

FIG. 2 illustrates an exemplary embodiment 200 utilizing keys and fasteners. It should be readily apparent to those of ordinary skill in the art that the embodiment 200 depicted in FIG. 2 represents a generalized schematic illustration and that other components may be added or existing components may be removed or modified.

As shown in FIG. 2, the embodiment 200 includes a rotor cylinder 205, multiple pole pieces 210, multiple fasteners 215, multiple retaining keys 220, multiple slot wedges 225, and multiple magnets 230.

The rotor cylinder 205 may be configured to be a substantially circular structure. The rotor cylinder 205 may be composed of a metallic material, for example aluminum, or a non-metallic material, for example ceramic, plastic or a reinforced composite material. The rotor cylinder 205 may be constructed as a solid piece or structural fabrication with a hollow center in order to reduce weight. In one embodiment, the rotor cylinder may include apertures or openings. The apertures may be precisely machined to center beneath a pole piece, thereby providing a method of precisely locating the pole pieces in a permanent magnet motor. The number of apertures per pole piece is a function of the length of the pole piece, diameter of attachment, diameter of the aperture and rotational speed. For example, the number of apertures for long pole piece may be substantially larger than the number of apertures for a shorter pole piece, where the apertures would be distributed axially along the rotor cylinder 205.

The pole pieces 210 may be implemented as a solid block of ferromagnetic material, a solid pole formed of individually isolated material or may be composed of a stack of laminated segments. Each pole piece 220 generally has a six-sided polyhedron, e.g., a block, where sides of the pole piece 220 are machined to abut, in a seamless fashion, the rotor cylinder, a slot wedge and magnets, respectively.

Each pole piece 210 may be configured with a horizontal opening that extends axially through the pole piece. Each pole piece 210 may also be configured with a vertical opening on the side of the pole piece, for example, the bottom thereof, that substantially abuts the rotor cylinder 205. The vertical opening may extend perpendicularly to the horizontal opening. The number of vertical openings may typically match the number of apertures of the rotor cylinder 205 for the given specification of the permanent magnet motor.

Each pole piece 210 may also be configured with a longitudinal groove on the axial sides. The longitudinal groove is adapted to receive one side of a slot groove. In some embodiments, the joint formed by the longitudinal groove and the slot wedge may be similar to a tongue-and-groove joint. In most embodiments, the joint formed by the longitudinal groove and the slot wedge is locking.

Each fastener member 215 may be a cylindrical structural member that provides a mechanism to attach a pole piece 210 to the rotor cylinder 205. More particularly, the fastener member 215 may include an opening at one of the fastener member 215. The opening may be adapted to substantially receive an associated retaining key 220. The other end of the fastener member 215 may be used to secure the fastener to the rotor cylinder. In some embodiments, the fastener member 215 may be threaded, e.g., a bolt. In other embodiments, the fastener member 215 may be implemented using metallic materials, non-metallic materials or some combination thereof.

Each retaining key 220 may be a bar of rigid material that is adapted to fit the horizontal opening of a pole piece and the opening of a fastener member 215. Unlike the prior art, the retaining key 220 is substantially a polyhedron, cylindrical or some solid of consistent dimensions. During the assembly process, the poles 210 or laminations are initially placed over the retaining keys 220 and the fasteners 215 are tightened to attach the poles to the rotor cylinder 205.

Each magnet 230 may be adapted to substantially seamlessly fit against two pole pieces 210, the rotor cylinder 205 and a slot wedge 225. Each magnet may be of the same length as the axial length of the rotor cylinder and the pole pieces or be in sections that add up to the length.

Each slot wedge 225 may be adapted to fit within the longitudinal grooves of two pole pieces 210. Each slot wedge 225 may be implemented using a substantially material such as a composite, ceramic, aluminum materials or some combination thereof. As described above, each slot wedge 225 may be adapted to form a locking joint with the adjoining pole pieces and thereby forming a housing to secure a magnet. The slot wedge 225, in some embodiments, may be substantially the same axial length as the magnets. However, in other embodiments, the slot wedge 225 may be slightly longer or shorter than the magnets. In yet other embodiments, the slot wedges 225 may be comprised of multiple segments forming a single slot wedge. In one embodiment, a pole piece arrangement may be formed by inserting the end of the fastener member 215 with the opening into the vertical opening of a selected pole piece 210. A retaining key 220 may be inserted into the horizontal opening of the pole piece 210 and through the aligned opening of the fastener member 215. Thus, the retaining key 220 forms a “T” joint with the fastener member 215. The fastener member 215 is then attached to the rotor cylinder 205. In a selected embodiment, a bolt may be threaded onto the fastener member 215. As the fastener member 215 is secured, the retaining key 220 exerts a downward force on the pole piece 210 and thus, securing the pole piece to the rotor cylinder 205.

After the pole pieces 210 are attached to a rotor cylinder 205 of a given electric motor, the pole pieces 210 are circumferentially distributed along the rotor cylinder 205. At this point, the attached pole pieces 210 on the rotor cylinder 205 resemble a gear when viewed from the axial perspective. Magnets 230 may be placed into the gap formed by two consecutive pole pieces 210 and an associated slot wedge 225 is then inserted into the longitudinal grooves of the two abutting pole pieces. The slot wedge 225 may lock in the magnet 230 and form the housing that holds the magnet 230 secure. In other embodiments, to assure the radial retention of the magnets 230 and slot wedges 225, the entire cylindrical surface is enclosed in an outer wrap formed from a fiber-reinforced organic or inorganic polymer composite material with wound fibers selected from glass, aramid, carbon polyester or quartz materials wrapped around the surface of the rotor. Preferably, the composite is created using a dry layup resin transfer molding or a wet or preimpregnated filament winding technique. Thus, the outer composite wrap constitutes a containment wall which opposes the centrifugal forces generated by the magnets and wedges during high speed rotation and provides a smooth cylindrical outer surface to help reduce windage losses.

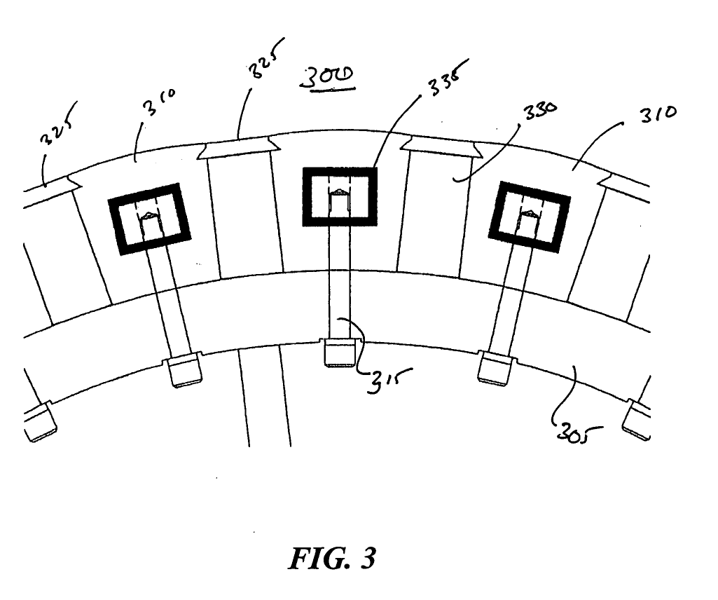

FIG. 3 illustrates another embodiment 300 utilizing square bars and fasteners. It should be readily apparent to those of ordinary skill in the art that the embodiment 300 depicted in FIG. 3 represents a generalized schematic illustration and that other components may be added or existing components may be removed or modified.

As shown in FIG. 3, embodiment 300 includes rotor cylinder 305, multiple pole pieces 310, multiple fasteners 315, multiple slot wedges 325, multiple magnets 330, and multiple square bars 335. The rotor cylinder 305, pole pieces 310, slot wedges 325, and magnets 330 are similar to the comparable components shown with respect to embodiment 200 (shown in FIG. 2). Instead of retaining keys to engage the fastener member 315, embodiment 300 may include a square bar member 335. The horizontal opening of the pole pieces 310 may be adapted to receive the square bar member 335. More particularly, the fasteners are drilled through from the inside diameter to the bar and threaded into the square bar member 335.

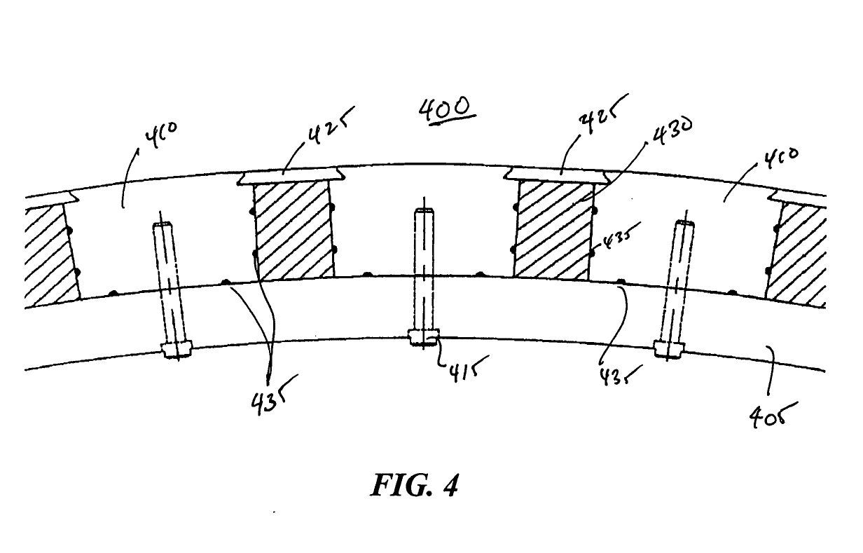

FIG. 4 illustrates an exemplary embodiment 400 utilizing welded poles and fasteners. It should be readily apparent to those of ordinary skill in the art that the embodiment 400 depicted in FIG. 4 represents a generalized schematic illustration and that other components may be added or existing components may be removed or modified.

As shown in FIG. 4, embodiment 400 includes a rotor cylinder 405, multiple pole pieces 410, multiple slot wedges 425, and magnets 430. These elements of embodiment 400 are similar to the respective components of embodiment 200 (shown in FIG. 2). However, the pole pieces 410 in embodiment do not include a horizontal opening. The pole pieces 410 include at least one vertical opening adapted to receive a fastener member 415.

In embodiment 400, the pole pieces 410 are stacked and welded on the edges to form a single solid polyhedron which is attached the rotor cylinder 405 by engaging the fastener member 415 through the respective aperture of the rotor cylinder 405 and vertical opening of the pole piece 410. After the pole pieces 410 are attached to the rotor cylinder 405, the magnets 430 are placed in the gap formed by two pole pieces 410 and slot wedges 425 may then be inserted to form the housing to hold the magnet 430 secure against the rotor cylinder 405.

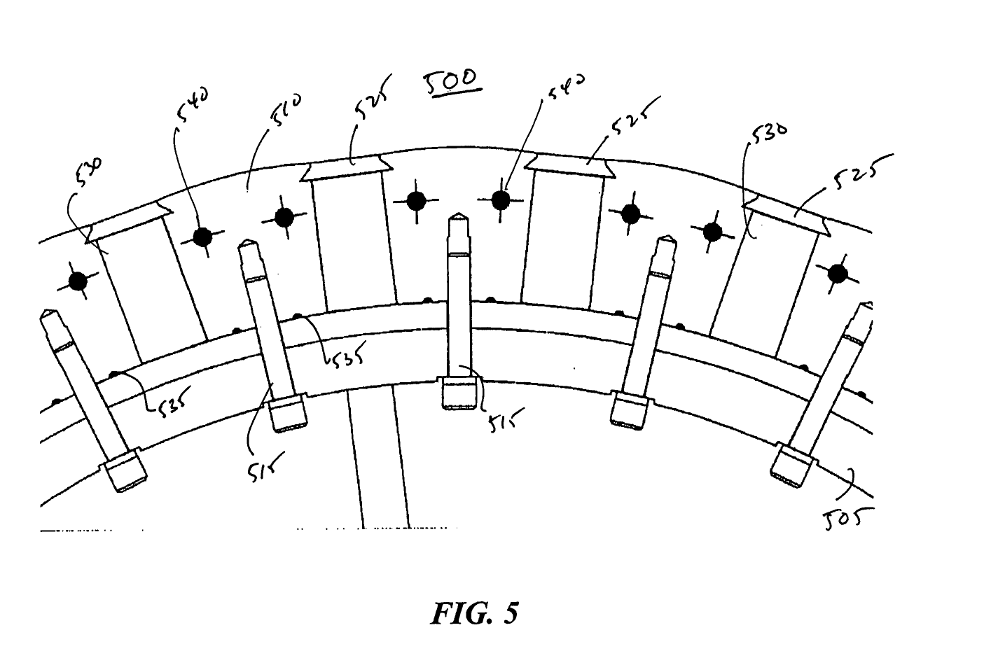

FIG. 5 illustrates an exemplary embodiment 500 utilizing welded poles, bars and fasteners. It should be readily apparent to those of ordinary skill in the art that the embodiment 500 depicted in FIG. 5 represents a generalized schematic illustration and that other components may be added or existing components may be removed or modified.

As shown in FIG. 5, embodiment 500 includes a rotor cylinder 505, multiple pole pieces 510, multiple slot wedges 525, and magnets 530. These elements of embodiment 500 are similar to the respective components of embodiment 200 (shown in FIG. 2). However, in this embodiment, the bars 540 are used to clamp the poles 510 axially and then welded. The inner diameter of the poles 510 are then drilled and threaded to accept the fasteners 515.

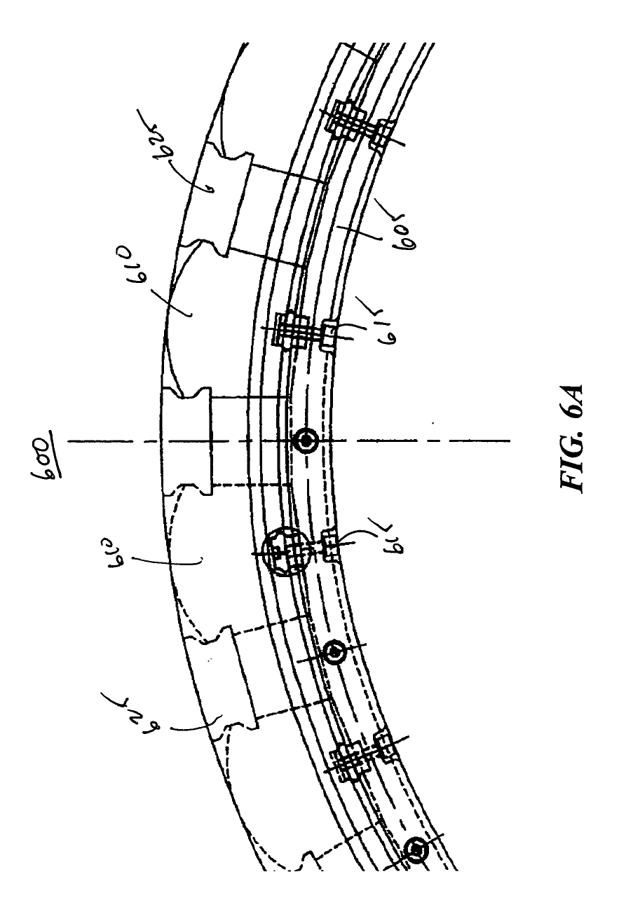

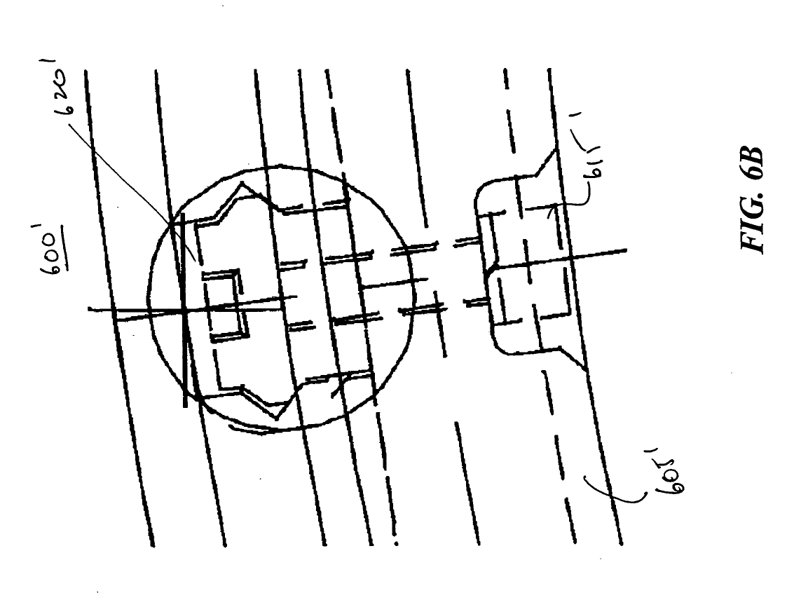

FIG. 6A illustrates an exemplary embodiment 600 utilizing expanding keys and fasteners. It should be readily apparent to those of ordinary skill in the art that the embodiment 600 depicted in FIG. 6A represents a generalized schematic illustration and that other components may be added or existing components may be removed or modified.

As shown in FIG. 6A, embodiment 600 includes a rotor cylinder 605, multiple pole pieces 610, multiple slot wedges 625, and magnets 630. These elements of embodiment 600 are similar to the respective components of embodiment 200 (shown in FIG. 2). The fasteners 615 are threaded into the keys 620 through ID holes. The keys 620 are shaped such that as they are tightened, an angled surface on the rotor cylinder 605 facing side, forces the pole 610 to spread tightening the pole against the magnets 630, and expanding the base of the poles.

FIG. 6B illustrates a more detailed exemplary embodiment 600′ utilizing sloped keys and fasteners. It should be readily apparent to those of ordinary skill in the art that the embodiment 600′ depicted in FIG. 6B represents a generalized schematic illustration and that other components may be added or existing components may be removed or modified.

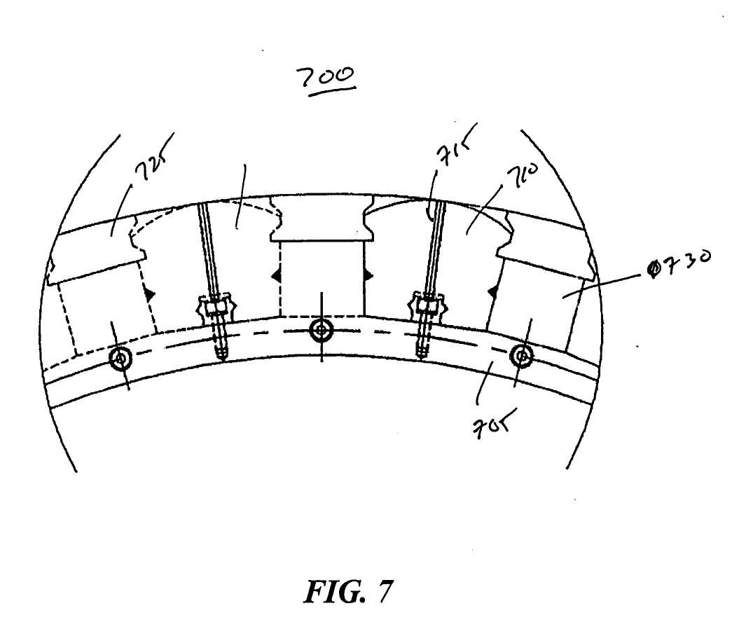

FIG. 7 illustrates an exemplary embodiment 700 utilizing expanding keys and fasteners, where the fasteners are attached from the outer surfaces. It should be readily apparent to those of ordinary skill in the art that the embodiment 700 depicted in FIG. 7 represents a generalized schematic illustration and that other components may be added or existing components may be removed or modified.

As shown in FIG. 7, embodiment 700 includes a rotor cylinder 705, multiple pole pieces 710, multiple slot wedges 725, and magnets 730. These elements of embodiment 700 are similar to the respective components of embodiment 200 (shown in FIG. 2). In this embodiment, the fasteners are predetermined in the poles 710. A hole 715 through the pole head 710 allows a tool to access the fastener for tightening.

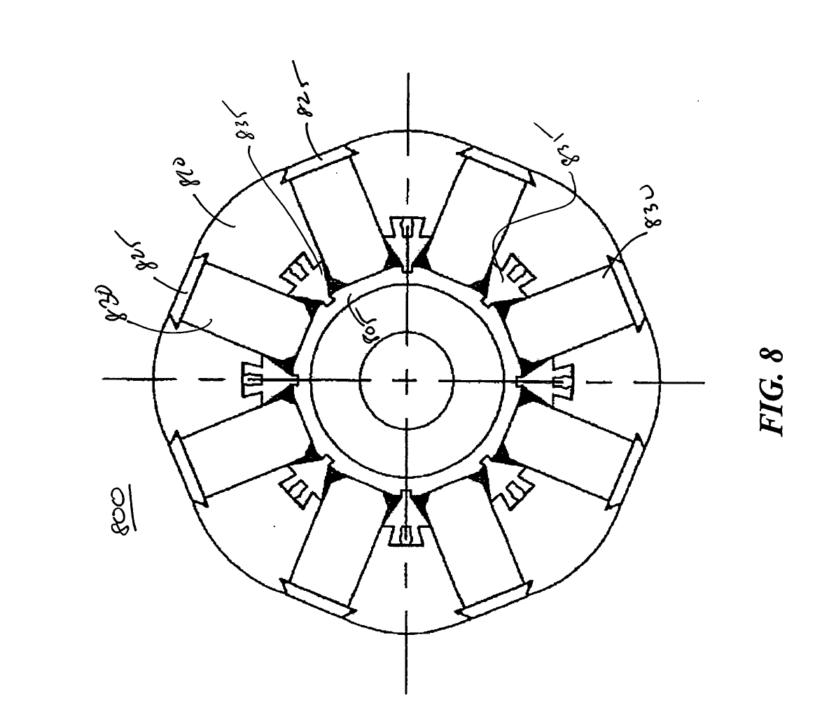

FIG. 8 illustrates an exemplary embodiment 800 utilizing keys and bars. It should be readily apparent to those of ordinary skill in the art that the embodiment 800 depicted in FIG. 8 represents a generalized schematic illustration and that other components may be added or existing components may be removed or modified.

As shown in FIG. 8, embodiment 800 includes a rotor cylinder 805, multiple pole pieces 810, multiple slot wedges 825, and magnets 830. These elements of embodiment 800 are similar to the respective components of embodiment 200 (shown in FIG. 2). The embodiment shown in FIG. 8 differs with the embodiment shown in FIG. 2 in that the poles 810 slide over dovetails 835 welded to the rotor cylinder 805. A key is inserted from the end to expand the dovetail 835 into the pole 810, resulting in a tightening. Accordingly, there is not a need for the use of fasteners.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A permanent magnet rotor arrangement comprising:
a rotor having a plurality of apertures;
a plurality of pole pieces;
a plurality of retaining keys, each retaining key adapted to abut a respective pole piece and the rotor;
a plurality of wedges; and
a plurality of permanent magnets, wherein each magnet is held immobile against the rotor by a two pole pieces of the plurality of pole pieces and an associated wedge from the plurality of wedges, each pole piece connected to the rotor by a retaining key held in place by a fastener pulled through an associated aperture and associated retaining key.

2. The permanent magnet rotor arrangement according to claim 1, wherein the plurality of permanent magnets are circumferentially distributed around the rotor.

3. The permanent magnet rotor arrangement according to claim 1, wherein the plurality of pole pieces are circumferentially distributed around the rotor.

4. The permanent magnet rotor arrangement according to claim 1, wherein each pole piece is configured to receive one side of a selected slot wedge of the plurality of wedges.

5. The permanent magnet rotor arrangement according to claim 4, wherein each pole piece includes a slot to receive one side of a selected wedge of the plurality of wedges.

6. The permanent magnet rotor arrangement according to claim 1, wherein the plurality of apertures are circumferentially distributed around the rotor.

7. The permanent magnet rotor arrangement according to claim 1, wherein the retaining key is substantially a polyhedron.

8. The permanent magnet rotor arrangement according to claim 1, wherein each pole piece comprises of multiple pieces welded as a single polyhedron.

9. The permanent magnet rotor arrangement according to claim 1, each retaining key of the plurality of keys is an expanding key.

10. The permanent magnet rotor arrangement according to claim 1, each retaining key of the plurality of keys is a sloping key.

11. A permanent magnet rotor arrangement comprising:
a rotor having a plurality of apertures;
a plurality of dovetails adapted to be attached to the rotor;
a plurality of pole pieces, each pole configured with an opening to receive an associated dovetail;
a plurality of permanent magnets, wherein each magnet is held substantially secure against the rotor by a two pole pieces of the plurality of pole pieces, the pole piece engaging a respective dovetail.

12. The permanent magnet rotor arrangement according to claim 11, wherein each dovetail is adapted to receive a key.

13. The permanent magnet rotor arrangement according to claim 12, wherein each dovetail is configured to expand into an engaged pole piece in response to the key being inserted.

14. A pole piece arrangement, comprising:
a rotor having a plurality of openings;
a pole piece having a horizontal opening through the length of the pole piece and a vertical opening to the horizontal opening;
a retaining member configured to engage the pole piece in the horizontal opening; and
a fastener engaging the retaining member through the vertical opening, wherein the pole piece is attached to the rotor through a selected opening of the plurality of openings.

15. The pole piece arrangement according to claim 14, wherein the retaining member is one of a key and a bar.

16. A pole piece arrangement, comprising:
a rotor having a plurality of openings;
a plurality of pole pieces, each pole piece having a horizontal opening through the length of the pole piece and a vertical opening to the horizontal opening;
a plurality of retaining members, each retaining member configured to engage an associated pole piece in the horizontal opening; and
a plurality of fasteners, each fastener engaging an associated retaining member through the vertical opening of a selected pole piece, wherein the selected pole piece is attached to the rotor through a selected opening of the plurality of openings.

17. The pole piece arrangement according to claim 16, further comprising:
a plurality of slot wedges; and
a plurality of magnets, each magnet held substantially secure against the rotor by adjacent pole pieces attached to the rotor and a selected slot wedge engaged with the adjacent pole pieces.

18. The pole piece arrangement according to claim 17, wherein each pole piece is configured with at least one notch configured to receive the selected slot wedge.

19. The pole piece arrangement according to claim 17, wherein the plurality of magnets are circumferentially distributed along the rotor.

20. The pole piece arrangement according to claim 17, wherein the plurality of pole pieces are circumferentially distributed along the rotor.
